(19) United States
(12) Patent Application Publication
(10) Pub. No.: US 2026/0361069 A1
(43) Pub. Date: Nov. 12, 2026

(54) IMPLEMENTING ERMS ON SINGLE SELF-POWERED RELAY WITHOUT EXTERNAL CONTROL POWER SUPPLY

(71) Applicant: SAUDI ARABIAN OIL COMPANY, Dhahran (SA)

(72) Inventors: Abdulaziz Alhanani, Khobar (SA); Nabil Elhalabi, Dhahran (SA); Sama Almubarak, Dhahran (SA); Ricardo Jose Guerra Castillo, Madrid (ES); Ayat Albuali, Dhahran (SA)

(73) Assignee: SAUDI ARABIAN OIL COMPANY, Dhahran (SA)

(21) Appl. No.: 19/203,442

(22) Filed: May 9, 2025

(51) Int. Cl. H02H 3/087; H02H 3/02

(52) U.S. Cl. CPC H02H 3/087; H02H 3/02

(57) ABSTRACT

A self-powered protective relay device for remote switchgear applications includes current transformers (CTs) configured to detect current in a primary circuit and supply power to the relay during elevated current conditions, an internal rectifier circuit receiving an input from the CTs and converting alternating current (AC) power to direct current (DC) power for operating relay electronics, a digital input circuit configured to detect an external contact position of an energy reduction maintenance switch (ERMS), and a processing unit configured to switch between at least two overcurrent protection setting groups. The digital input circuit is powered internally by DC output of the rectifier circuit. In addition, the capacitor is connected in parallel with the digital input circuit.

### BACKGROUND

The invention introduces a new self-powered relay design for outdoor SF6 switchgear that eliminates the need for an external control power supply to enable Energy Reducing Maintenance Switch (ERMS) functionality. The ERMS is a physical switch that, when activated, changes the relay's overcurrent settings to an instantaneous and more sensitive mode, thereby reducing arc flash incident energy for downstream equipment. Traditionally, energizing the self-powered relay's digital input in maintenance mode (ERMS activated) requires an external control power supply, which is difficult to provide in outdoor SF6 switchgear.

To address this challenge, the invention proposes an internal hardware modification to the self-powered relay. Through an internal rectifier (powered by the relay's current transformers, or CTs), the digital input is supplied with sufficient energy internally. In the event of a fault, high current flows through the CTs, energizing both the relay and the digital input if the ERMS switch is in the maintenance position. As soon as the input is energized within the relay's standard processing time, the relay automatically switches to the ERMS settings group and operates instantaneously without relying on any external control power source.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments of the invention relate to a self-powered protective relay for switchgear applications. The relay is connected to current transformers (CTs) configured to detect current in a primary circuit and supply power to the relay during elevated current conditions and an internal rectifier circuit receiving an input from the CTs and converting alternating current (AC) power to direct current (DC) power for operating relay electronics. The relay further includes a digital input circuit configured to detect an external contact position of an energy reduction maintenance switch (ERMS), and a processing unit configured to switch between at least two overcurrent protection setting groups. The digital input circuit is powered internally by DC output of the rectifier circuit. In addition, the capacitor is connected in parallel with the digital input circuit.

In general, in one aspect, embodiments of the invention relate to a non-transitory computer-readable medium containing instructions that, when executed by a processor, cause the processor to perform steps. The steps include receiving input from CTs configured to detect current in a primary circuit and supply power to a relay during elevated current conditions; converting AC power received from the CTs into DC power using an internal rectifier circuit to operate relay electronics; and detecting an external contact position of an ERMS through a digital input circuit, wherein the digital input circuit is powered internally by DC output of the rectifier circuit. The steps may further include storing charge in a capacitor connected in parallel with the digital input circuit to smooth and sustain the rectifier output voltage for the digital input circuit and ensure continuous operation during current fluctuations; and determining and switching between at least two overcurrent protection setting groups.

Other aspects and advantages of the invention will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. Like elements may not be labeled in all figures for the sake of simplicity.

FIG. 1 shows a relay output circuit in accordance with various embodiments;

FIG. 2 shows a flowchart in accordance with various embodiments;

FIG. 3 shows a block diagram of a computer system in accordance with various embodiments.

### DETAILED DESCRIPTION

In the following detailed description of embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

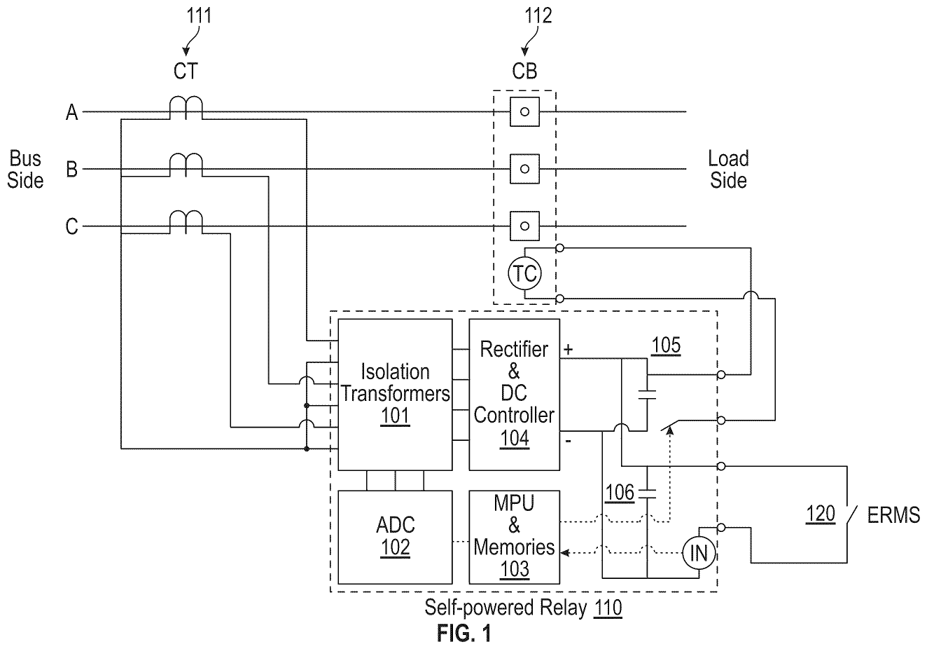

In the following description of FIGS. 1-3, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that, one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Currently, arc flashes pose a significant safety hazard in medium voltage power distribution systems, with the potential to cause severe injuries to personnel and substantial equipment damage. These incidents occur when electrical energy explosively discharges due to elevated current conditions such as faults or accidental contact with live components. To mitigate arc flash risks, one common approach is to temporarily enable instantaneous overcurrent protection during maintenance work using Energy Reduction Maintenance Switches (ERMS).

The ERMS connects to the relay's digital input and allows the relay to switch between two settings: maintenance mode (instantaneous overcurrent protection) and normal operation. Maintenance mode features more sensitive and faster protection settings, reducing arc flash incident energy on downstream equipment and enhancing personnel safety during operation and maintenance.

Self-powered relays, widely used in outdoor installations such as SF6 gas-insulated switchgear, are advantageous because they operate without an external power source, drawing energy instead from current transformers (CTs). However, this reliance on CTs presents a challenge for implementing ERMS, as the ERMS requires power to energize the relay's digital inputs.

To address this limitation, a common approach has been to use two separate relays: one for normal operation and another for maintenance mode, enabled by the ERMS connected to the CT secondaries. While effective, this method increases costs and system complexity and introduces the risk of CT open circuit failures if the ERMS malfunctions.

Embodiments disclosed herein provide a streamlined solution by redesigning the internal circuitry of self-powered relays to enable seamless switching between settings groups based on the ERMS position, without requiring an external power supply. The invention will address the need for the control supply challenge by designing the internal hardware of the self-powered relay to provide the required energy to the digital input internally through the relay rectifier built into the self-power relay which is supplied by the current transformers (CTs). By utilizing an internal rectifier powered by the CTs, the relay's digital input can be energized directly, allowing the relay to switch to maintenance settings when the ERMS is activated. This innovation reduces costs, simplifies system design, and enhances reliability, making it especially valuable for outdoor and remote installations where external power sources are impractical to provide.

In a traditional configuration of an ERMS, a self-powered relay would be connected to the secondary windings of current transformers installed on the primary circuit of a feeder. The CTs derive energy from the current flowing through the primary circuit. When the current exceeds approximately 20% of the CT's rated current, the relay is energized.

In the traditional configuration of the ERMS, the relay output circuit is energized through the rectifier and DC. A capacitor is integrated into the output circuit to store energy, ensuring that sufficient power is available to operate the circuit breaker (CB) trip coil (TC) or striker when a fault is detected. The trip coil is a key component of the circuit breaker. When the self-powered relay detects a fault, it sends a signal to the TC to open the circuit breaker. The TC is energized by the relay's output, which is powered by the rectifier and supported by the capacitor to ensure sufficient energy is available for operation during a fault condition.

In the traditional configuration of the ERMS, the digital input (IN) of the self-powered relay requires an external power source to enable features like the Energy Reduction Maintenance Switch (ERMS) 120. When ERMS is activated, the relay must switch from normal operating settings to instantaneous protection settings. The reliance on an external power supply for the digital input creates challenges, particularly for outdoor installations where providing external power is difficult.

However, this traditional approach increases the complexity and cost of the system. It also introduces risks, such as the possibility of an open circuit in the CT secondary if the ERMS malfunctions.

According to one or more embodiments, FIG. 1 illustrates the proposed design of a self-powered relay 110 with integrated improvements to enable ERMS functionality without the need for an external power supply. In the proposed design, the relay's digital input circuit is internally connected to the rectifier, which supplies the necessary energy to activate the digital input based on the external contact position of the ERMS.

More specifically, according to FIG. 1, embodiments of the invention may include Current Transformers (CTs) 111, Isolation Transformers 101, Rectifier and DC Controller 104, Analog-to-Digital Converter (ADC) 102, Microprocessor Unit (MPU) and Memories 103, Digital Input IN, Capacitors 105 and 106, Circuit Breaker (CB) 112, and Energy Reduction Maintenance Switch (ERMS) 120.

The CTs 111 are responsible for measuring the current flowing through the primary circuit and stepping it down to a manageable level for the relay's operation. The CTs 111 generate the energy needed to power the self-powered relay 110 by capturing the primary circuit's current and providing a proportional secondary current. They act as the main energy source for the relay system 110.

The isolation transformers 101 electrically separate the CTs'secondary circuit from the relay's internal components. This ensures safety by preventing direct coupling between the external CT circuit and the sensitive internal circuitry of the relay 110. In other words, the isolation transformers 101 provides galvanic isolation between the CT secondary circuit and the internal relay circuitry, ensuring electrical safety and stable power conversion for relay operation. It also protects the relay 110 from potential electrical surges and ensures reliable signal transmission.

The rectifier and DC controller 104 convert the alternating current (AC) from the isolation transformer into direct current (DC). This DC power, typically at 24 VDC, is used to energize the relay's internal circuitry, including its processing and decision-making components. The rectifier also powers other key functions, such as the relay output and digital input circuits.

The ADC 102 converts the analog signals received from the CTs 111 into digital signals. These digital signals are then processed by the relay's microprocessor for monitoring and protection functions. The ADC 102 is a critical component for enabling precise fault detection and relay operation.

The microprocessor unit (MPU) and memory modules 103 handle the relay's logic and decision-making processes. The MPU processes data received from the ADC 102 and controls the relay's response to various operating conditions, such as detecting faults or switching between normal and maintenance settings. Memory components store the relay's settings, including the ERMS mode configurations.

The digital input circuit is internally connected to the relay's rectifier. It enables the relay 110 to detect the position of the Energy Reduction Maintenance Switch (ERMS). When the ERMS is activated, the digital input circuit receives the required energy to switch the relay 110 to maintenance mode. A capacitor 106 is included in the circuit to stabilize energy supply in case of rectifier output fluctuations.

In one or more embodiments, the capacitor 106 is connected in parallel with the digital input circuit to store charge and thereby maintain a stable voltage across the digital input even under rapidly changing current conditions. When the fault current fluctuates, such as during transient events or when protective devices begin to operate, the power available from the CTs may momentarily dip. By accumulating and holding charge from the rectifier output, the capacitor effectively bridges these dips and ensures that the digital input circuit remains energized long enough for the relay's processor to reliably detect the ERMS status.

In one or more embodiments, the circuit breaker (CB) 112 includes a trip coil. The CB 112 is part of the protection system which isolates the faulty circuit from the system when a fault is detected. The CB 112 is controlled by the trip coil, which receives its activation signal from the relay 110.

When the relay 110 detects an elevated current conditions such as a fault, it sends a signal to energize the trip coil. This causes the circuit breaker 112 to open, interrupting current flow and isolating the faulted circuit. The trip coil is powered by the relay's output, which is supported by the capacitor 105 to ensure sufficient energy is available during critical operations. In one or more embodiments, the digital input of the relay is low burden consuming as low as 5 mA at 24 VDC. Therefore, there will be sufficient energy provided by the rectifier to energize both the digital input and trip coil during faults.

The ERMS 120 is a switch that allows the relay 110 to switch between normal and maintenance mode. When activated, the ERMS 120 positions the relay 110 into maintenance mode with instantaneous and sensitive overcurrent protection settings to reduce arc flash incident energy and enhance safety during maintenance.

Under normal operating conditions, when the ERMS 120 is off, the relay 110 operates using its normal settings. These settings are coordinated for normal system operation. However, during operation or maintenance of downstream equipment, the ERMS 120 is enabled to enhance safety. In such situations, the downstream load is usually disconnected, and no current flows through the primary circuit. As a result, the self-powered relay 110 remains off and unable to detect the status of the ERMS 120.

When a fault occurs on the downstream equipment, a high current flows through the primary circuit, powering up the relay 110 via the CTs 111. In this scenario, if the ERMS 120 is in maintenance mode, the relay's digital input is energized through the rectifier 104. This allows the relay 110 to switch to its maintenance settings, which are more sensitive and designed for instantaneous operation to minimize arc flash incident energy. While the fault current persists, the relay 110 remains energized, and the digital input IN remains active. To address potential fluctuations in the CT 111 output and to smooth the rectifier output, a capacitor 106 in the digital input circuit sustains the input voltage and ensures reliable operation.

The relay 110 is specifically designed to account for the time required to energize the digital input IN and switch to the maintenance settings when the ERMS 120 is active. While this process may add a few cycles to the relay's overall processing time, which may result in a slight increase in the operating time for the maintenance overcurrent settings, the delay has a negligible impact on reducing arc flash incident energy. This system ensures both safety and effective system protection during maintenance operations.

In one embodiment, the MPU and memories 103 is configured to determine whether the relay 110 should operate under a normal overcurrent protection setting group or a maintenance overcurrent protection setting group based on the status of the digital input connected to the ERMS 120. When the ERMS 120 is detected as being in maintenance mode, the processor automatically selects a higher-sensitivity and instantaneous overcurrent protection group to reduce incident energy during fault conditions. Conversely, when the ERMS 120 is disabled or in the off position, the relay 110 reverts to its normal overcurrent protection setting group. This determination involves monitoring the digital input signal, which is powered internally by the relay's rectifier and stabilized by a capacitor during current fluctuations. Once the digital input signal indicates the ERMS 120 is in maintenance mode, the processor executes a control routine to switch to the maintenance setting group. This switching occurs within a predetermined number of cycles to ensure that the faster protection settings are applied rapidly enough to mitigate the risk of arc flash or other fault-related hazards.

In typical medium-voltage protection schemes, the relay operates under normal overcurrent settings that incorporate a time-delayed overcurrent threshold. These thresholds are often implemented using either an inverse-time characteristic or a definite-time delay, or a combination of both, to ensure proper coordination with upstream and downstream protective devices. Under normal conditions, the time-delayed overcurrent protection allows for brief, permissible overcurrent events to pass without causing an immediate trip. This coordination approach helps maintain service continuity and prevents unnecessary outages in the event of short-term or transient overcurrent situations. In contrast, when the ERMS is enabled, the relay bypasses or substantially reduces the time delay by utilizing instantaneous or faster tripping thresholds, thereby minimizing arc flash incident energy during a fault under maintenance conditions.

Embodiments disclosed herein offer several key advantages over traditional implementations of ERMS in self-powered relay systems.

First, the cost efficiency is significantly improved. By integrating the digital input power supply within the relay itself, the need for two separate relays is eliminated. This reduces both the upfront cost of equipment and the complexity of the overall system and results in a more affordable solution for ERMS implementation.

Second, the design provides enhanced safety and reliability. By avoiding the use of multiple relays, the risks associated with switching between relays, such as potential CT circuit interruptions or open-circuit faults, are effectively eliminated. The system ensures dependable ERMS functionality and improve safety for personnel and equipment, even under challenging conditions.

Finally, the invention features a simplified design, which integrates the necessary power supply for the digital input directly into the relay's internal circuitry. This streamlined approach simplifies both installation and maintenance, particularly in outdoor environments where external power sources are difficult to provide. The reduction in external dependencies makes the system more robust and easier to manage for remote switchgears applications.

In one or more embodiments, this invention may be applied in power distribution systems, particularly in scenarios where safety and reliability are important.

In one or more embodiments, one primary application of the invention is in outdoor switchgear installations. In these situations, providing an external power source is often challenging or impractical. The self-contained power supply within the relay makes it ideal for such scenarios, which enables reliable ERMS functionality without additional infrastructure.

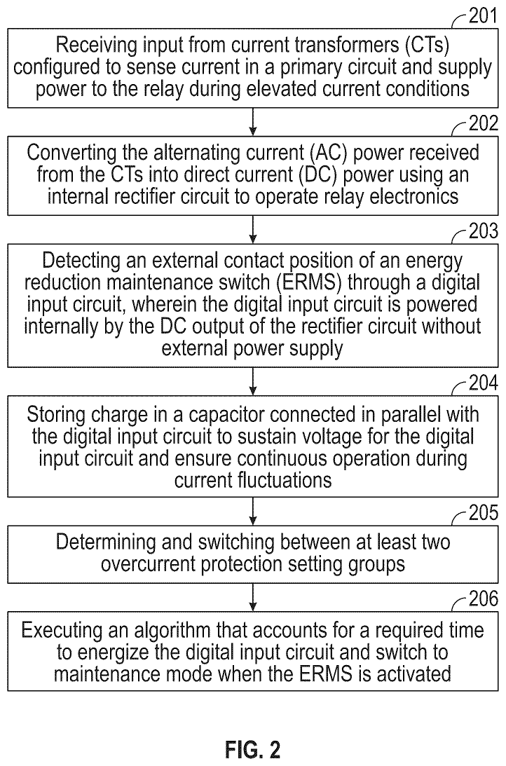

FIG. 2 shows a flowchart in accordance with various embodiments.

Step 201 includes receiving input from current transformers (CTs) configured to sense current in a primary circuit and supply power to the relay during elevated current conditions.

In this step, the self-powered relay is connected to CTs that are placed around conductors in the primary circuit. As current flows through the primary circuit, each CT produces a proportional secondary current that is routed into the relay. When the current in the primary circuit exceeds a threshold (often during fault or high overloading conditions), the CT output rises sufficiently to power the relay.

Step 202 includes converting the alternating current (AC) power received from the CTs into direct current (DC) power using an internal rectifier circuit to operate relay electronics.

Once the AC signal from the CTs enters the relay, it passes through an internal rectifier stage. This rectifier can include an isolation transformer and a diode bridge or similar circuitry that converts the incoming AC power into regulated DC voltage. The rectified DC is then used to supply the relay's control electronics, microprocessor, and other functional circuits.

Step 203 includes detecting an external contact position of the ERMS through a digital input circuit, wherein the digital input circuit is powered internally by the DC output of the rectifier circuit.

In this step, the relay's digital input circuitry is designed so that it does not require an external auxiliary power supply. Instead, the same DC power produced in Step 202 is used to energize the input that detects the status (open or closed) of the ERMS. When the ERMS contact is closed (indicating the switch is in maintenance mode), the relay detects this change via the internally powered digital input.

Step 204 includes storing charge in a capacitor connected in parallel with the digital input circuit to sustain voltage for the digital input circuit and ensure continuous operation during current fluctuations.

In this step, because the relay relies on current from the CTs, the amplitude of this current can vary significantly, especially in the presence of fault conditions or transient events. To address these fluctuations, a capacitor is placed in parallel with the digital input circuit. This capacitor stores electrical charge and releases it as needed to maintain a stable voltage level at the digital input. As a result, brief dips or oscillations in the CT-supplied power do not interrupt the functioning of the digital input.

Step 205 includes determining and switching between at least two overcurrent protection setting groups.

In this step, the protective relay is configured with at least two distinct sets of overcurrent protection settings: one for normal operating conditions and another for maintenance mode. Upon detecting the ERMS contact in the closed position, the relay transitions from its normal protection setting group to a more sensitive and instantaneous overcurrent setting group. These maintenance settings are designed to clear faults quickly, thereby reducing arc-flash incident energy. Conversely, when the ERMS is open, the relay reverts to its normal protection settings for standard operation.

Step 206 includes executing an algorithm that accounts for a required time to energize the digital input circuit and switch to maintenance mode when the ERMS is activated.

Finally, in this step, the relay's processor executes a programmed algorithm that orchestrates the timing and sequence of events. Upon detecting the rising voltage at the digital input, the processor recognizes the need to switch settings but also factors in a brief energizing period. This short delay ensures the digital input is fully powered and the relay processor has completed all necessary data acquisition steps before switching to the maintenance settings. Although this adds a small number of cycles to the overall response, it remains minimal compared to the accelerated tripping benefit of the instantaneous maintenance protection, thus effectively minimizing arc-flash energy while maintaining reliable fault detection.

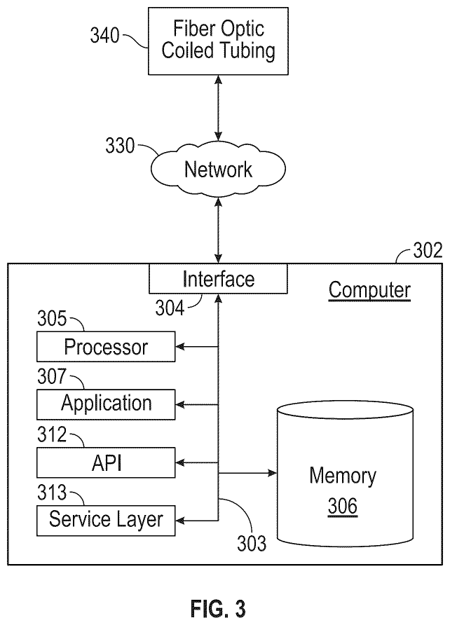

FIG. 3 shows a block diagram of a computer system 302 used to provide computational functionalities associated with described models, methods, functions, processes, flows, and procedures as described in the instant disclosure, according to an implementation. In the context of the present invention, the computer system 302 may be implemented as an embedded controller within the self-powered protective relay. This system 302 executes control algorithms to monitor input from CTs, detect the status of the ERMS via the digital input circuit, and manage the transition between protection setting groups. The processor 305 illustrated in FIG. 3 correspond to the MPU described throughout this disclosure and may operate entirely from power derived via the rectifier system inside the self-powered relay without requiring any external control power. This embedded implementation ensures that relay functionality such as fault detection, ERMS responsiveness, and trip signal generation may be reliably carried out in field-deployed environments.

The illustrated computer 302 is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 302 may include a computer that includes an input device, such as a keypad, keyboard, touch screen, or other device that can accept user information, and an output device that conveys information associated with the operation of the computer 302, including digital data, visual, or audio information (or a combination of information), or a GUI.

In certain embodiments, the functionality described herein can be implemented in software or firmware stored on a non-transitory computer-readable medium. In such a configuration, the protective relay includes or is in communication with a computer 302. The computer 302 can serve in a role as a client, network component, a server, a database or other persistency, or any other component (or a combination of roles) of a computer system for performing the subject matter described in the instant disclosure. The illustrated computer 302 is communicably coupled with a network 330. In some implementations, one or more components of the computer 302 may be configured to operate within environments, including cloud-computing-based, local, global, or other environment (or a combination of environments).

At a high level, the computer 302 is an electronic computing device operable to receive, transmit, process, store, or manage data and information associated with the described subject matter. According to some implementations, the computer 302 may also include or be communicably coupled with an application server, e-mail server, web server, caching server, streaming data server, business intelligence (BI) server, or other server (or a combination of servers).

The computer 302 can receive requests over network 330 from a client application (for example, executing on another computer 302) and responding to the received requests by processing the said requests in an appropriate software application. In addition, requests may also be sent to the computer 302 from internal users (for example, from a command console or by other appropriate access method), external or third-parties, other automated applications, as well as any other appropriate entities, individuals, systems, or computers.

Each of the components of the computer 302 can communicate using a system bus 303. In some implementations, any or all of the components of the computer 302, both hardware or software (or a combination of hardware and software), may interface with each other or the interface 304 (or a combination of both) over the system bus 303 using an application programming interface (API) 312 or a service layer 313 (or a combination of the API 312 and service layer 313. The API 312 may include specifications for routines, data structures, and object classes. The API 312 may be either computer-language independent or dependent and refer to a complete interface, a single function, or even a set of APIs. The service layer 313 provides software services to the computer 302 or other components (whether or not illustrated) that are communicably coupled to the computer 302. The functionality of the computer 302 may be accessible for all service consumers using this service layer. Software services, such as those provided by the service layer 313, provide reusable, defined business functionalities through a defined interface. For example, the interface may be software written in JAVA, C++, or other suitable language providing data in extensible markup language (XML) format or other suitable format. While illustrated as an integrated component of the computer 302, alternative implementations may illustrate the API 312 or the service layer 313 as stand-alone components in relation to other components of the computer 302 or other components (whether or not illustrated) that are communicably coupled to the computer 302. Moreover, any or all parts of the API 312 or the service layer 313 may be implemented as child or sub-modules of another software module, enterprise application, or hardware module without departing from the scope of this disclosure.

The computer 302 includes an interface 304. Although illustrated as a single interface 304 in FIG. 3, two or more interfaces 304 may be used according to particular needs, desires, or particular implementations of the computer 302. The interface 304 is used by the computer 302 for communicating with other systems in a distributed environment that are connected to the network 330. Generally, the interface 304 includes logic encoded in software or hardware (or a combination of software and hardware) and operable to communicate with the network 330. More specifically, the interface 304 may include software supporting one or more communication protocols associated with communications such that the network 330 or interface's hardware is operable to communicate physical signals within and outside of the illustrated computer 302.

The computer 302 includes at least one computer processor 302. Although illustrated as a single computer processor 302 in FIG. 3, two or more processors may be used according to particular needs, desires, or particular implementations of the computer 302. Generally, the computer processor 302 executes instructions and manipulates data to perform the operations of the computer 302 and any ML models, methods, functions, processes, flows, and procedures as described in the instant disclosure.

The computer 302 also includes a memory 305 that holds data for the computer 302 or other components (or a combination of both) that can be connected to the network 330. For example, memory 305 can be a database storing data consistent with this disclosure. Although illustrated as a single memory 305 in FIG. 3, two or more memories may be used according to particular needs, desires, or particular implementations of the computer 302 and the described functionality. While memory 305 is illustrated as an integral component of the computer 302, in alternative implementations, memory 305 can be external to the computer 302.

The application 307 is an algorithmic software engine providing functionality according to particular needs, desires, or particular implementations of the computer 302, particularly with respect to functionality described in this disclosure. For example, application 307 can serve as one or more components, modules, applications, etc. Further, although illustrated as a single application 307, the application 307 may be implemented as multiple applications 307 on the computer 302. In addition, although illustrated as integral to the computer 302, in alternative implementations, the application 307 can be external to the computer 302.

There may be any number of computers 302 associated with, or external to, a computer system containing computer 302, each computer 302 communicating over network 330. Further, the term “client,” “user,” and other appropriate terminology may be used interchangeably as appropriate without departing from the scope of this disclosure. Moreover, this disclosure contemplates that many users may use one computer 302, or that one user may use multiple computers 302.

In some embodiments, the computer 302 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

Add few lines that talk about how this will be used in context of relays.

What is claimed is:

1. A self-powered protective relay device for switchgear applications, comprising:
current transformers (CTs) configured to detect current in a primary circuit and supply power to the relay during elevated current conditions,
an internal rectifier circuit receiving an input from the CTs and converting alternating current (AC) power to direct current (DC) power for operating relay electronics,
a digital input circuit configured to detect an external contact position of an energy reduction maintenance switch (ERMS), and
a processing unit configured to switch between at least two overcurrent protection setting groups,
wherein the digital input circuit is powered internally by DC output of the rectifier circuit without external power supply,
wherein a capacitor is connected in parallel with the digital input circuit.

2. The self-powered protective relay device of claim 1, further comprising isolation transformers that provide galvanic isolation.

3. The self-powered protective relay device of claim 1, further comprising Analog-to-Digital Converter (ADC) that converts analog signals from the current transformers into digital signals.

4. The self-powered protective relay device of claim 3, wherein the processing unit processes the digital signals from the ADC and controls the self-powered protective relay device to respond to various operating conditions.

5. The self-powered protective relay device of claim 1, wherein the capacitor ensures the digital input circuit remains energized for the relay to detect during elevated current conditions.

6. The self-powered protective relay device of claim 1, wherein the at least two overcurrent protection setting groups include a normal overcurrent protection settings and a maintenance overcurrent protection settings, and the self-powered protective relay device switches to the maintenance overcurrent protection settings when the ERMS is on and elevated current conditions occur.

7. The self-powered protective relay device of claim 6, wherein the normal overcurrent protection settings include a time-delayed overcurrent protection threshold.

8. The self-powered protective relay device of claim 6, wherein the maintenance overcurrent protection settings apply instantaneous overcurrent protection settings within a number of cycles.

9. The self-powered protective relay device of claim 1, wherein the digital input circuit consumes no more than 5 mA at 24 VDC.

10. The self-powered protective relay device of claim 1, wherein the processing unit executes an algorithm that accounts for required time to energize the digital input circuit and switch to maintenance mode when the ERMS is activated.

11. A non-transitory computer-readable medium containing instructions that, when executed by a processor, cause the processor to perform steps that include:
receiving input from current transformers (CTs) configured to detect current in a primary circuit and supply power to a relay device during elevated current conditions;
converting alternating current (AC) power received from the CTs into direct current (DC) power using an internal rectifier circuit to operate relay electronics;
detecting an external contact position of an energy reduction maintenance switch (ERMS) through a digital input circuit, wherein the digital input circuit is powered internally by DC output of the rectifier circuit without external power supply;
storing charge in a capacitor connected in parallel with the digital input circuit to sustain voltage for the digital input circuit and ensure continuous operation during current fluctuations;
determining and switching between at least two overcurrent protection setting groups.

12. The non-transitory computer-readable medium of claim 11, wherein the at least two overcurrent protection setting groups include a normal overcurrent protection settings and a maintenance overcurrent protection settings.

13. The non-transitory computer-readable medium of claim 12, wherein the normal overcurrent protection settings include a time-delayed overcurrent protection threshold.

14. The non-transitory computer-readable medium of claim 12, wherein the maintenance overcurrent protection settings apply instantaneous overcurrent protection settings within a number of cycles.

15. The non-transitory computer-readable medium of claim 11, wherein the steps further include executing an algorithm that accounts for a required time to energize the digital input circuit and switch to maintenance mode when the ERMS is activated.
